(19) United States
(12) Patent Application Publication
(10) Pub. No.: US 2007/0156784 A1
(43) Pub. Date: Jul. 5, 2007

(54) Device management system, device management method, and storage medium

(75) Inventor: Hirokazu Yamamoto, Osaka-shi (JP)

Correspondence Address: KANESAKA BERNER AND PARTNERS LLP, 1700 DIAGONAL RD, SUITE 310, ALEXANDRIA, VA, 22314-2848, US

(73) Assignee: KYOCERA MITA CORPORATION, Osaka-shi (JP)

(21) Appl. No.: 11/543,792

(22) Filed: Oct. 6, 2006

(30) Foreign Application Priority Data
Dec. 21, 2005 (JP) 2005-368820

(51) Int. Cl. G06F 17/30

(52) U.S. Cl. 707/203

(57) ABSTRACT

There is provided a device management system in which a management apparatus is connected, through a communication line, to a management target device which is managed by the management apparatus. When a counter value for the number of occurrences of changes in state information which is obtained from the management target device matches a counter value stored in storage means of the management apparatus, the management apparatus outputs an instruction to display state information which is stored in the storage means on display means. When it is determined that they do not match, the management apparatus outputs an instruction to display state information which is obtained from the management target device on the display means and stores the obtained state information and counter value in the storage means.

### BACKGROUND OF THE INVENTION

1. Field of the Invention

The present invention relates to a device management system in which a management apparatus is connected, through a communication line, to a management target device which is managed by the management apparatus, a device management method, and a storage medium.

2. Description of the Related Art

In recent years, along with the development of IT technology, computers and LAN related devices have become less expensive. Thus, in corporations, various business-use devices (personal computers, printers, copying machines, etc.) are actively adopted.

In addition, in corporations, a plurality of business-use devices are networked together and thus network operation and management are performed.

Conventionally, when a state of mounting of optional devices for paper feeding and discharge and the like, of an image forming apparatus (management target device) which is network-connected is obtained, by using an SNMP, from application software (utility software, printer driver and the like) which is installed on a client apparatus (management apparatus), and the state is reflected on a screen of the application software, a method is used in which all information (MIB) necessary for screen display is obtained at a certain polling interval (an interval that is set by the application software) upon start-up of the application software or by a user instruction, and if there is a change in mounting state from that obtained last time, the display is updated to the current latest one (see Japanese Patent Application Laid-open No. 2000-347976, for example).

### SUMMARY OF THE INVENTION

In the aforementioned Japanese Patent Application Laid-open No. 2000-347976, however, even when there is no change in mounting state of the optional devices of the image forming apparatus, the application software on the client apparatus side needs to obtain all information necessary for screen display every time.

Hence, there are problems of an increase in the processing load of the client apparatus side and in network traffic.

The present invention is made in view of the foregoing and other problems. An object of the present invention is therefore to provide a device management system, a device management method, and a storage medium, which allow for a reduction in the processing load of a management apparatus side and traffic on a communication line.

To attain the above-described object, a first aspect of the present invention is directed to a device management system having: state management means for managing state information on a management target device; information storage means for storing the state information and change occurrence information on the state information; request response means for transmitting response information in response to a transmission request from a management apparatus; monitoring means for determining whether state information which is managed by the state management means has been changed from the state information stored in the information storage means, storing, if it is determined that the state information has been changed, the changed state information and updated information on the change occurrence information in the information storage means, and outputting, when receiving a transmission request from the management apparatus, to the request response means an instruction to transmit the state information or the change occurrence information which is stored in the information storage means to the management apparatus in response to the transmission request; the management target device including the state management means, the information storage means, the request response means, and the monitoring means; transmission/reception means for transmitting a transmission request to the management target device and receiving response information in response to the transmission request; storage means for storing the state information and the change occurrence information; management means for outputting to the transmission/reception means an instruction to request to the management target device to transmit the change occurrence information, determining whether the change occurrence information obtained from the management target device matches the change occurrence information stored in the storage means, and outputting, if it is determined that they match, an instruction to display the state information which is stored in the storage means on display means, and outputting, if it is determined that they do not match, to the transmission/reception means an instruction to request to the management target device to transmit the state information, outputting an instruction to display the state information which is obtained from the management target device on the display means, and storing the state information and the change occurrence information which are obtained from the management target device in the storage means; and the management apparatus including the transmission/reception means, the storage means, and the management means, and connected to the management target device through a communication line.

According to the above-described configuration, when change occurrence information obtained from the management target device matches change occurrence information stored in the storage means of the management apparatus, the management apparatus outputs an instruction to display state information which is stored in the storage means on the display means. When it is determined that they do not match, the management apparatus outputs an instruction to display state information which is obtained from the management target device on the display means.

Thus, only when change occurrence information obtained from the management target device does not match change occurrence information stored in the storage means of the management apparatus, the management apparatus accesses the management target device and obtains state information from the management target device.

By this, the processing load of the management apparatus can be reduced and the number of accesses to the management target device from the management apparatus can be reduced. Accordingly, the traffic on a communication line can be reduced.

According to a second aspect of the present invention, in the device management system according to the first aspect, the change occurrence information stored in the information storage means may be a counter value for a number of occurrences of changes and may be updated by incrementing the counter value.

According to the above-described configuration, even when the management target device is powered off, change occurrence information stored in the information storage means can be held.

According to a third aspect of the present invention, in the device management system according to the first or second aspect, the management target device may be an image forming apparatus.

According to a fourth aspect of the present invention, in the device management system according to the third aspect, the state information may be state information on whether an optional paper-feeding device and/or an optional paper-discharge device are/is mounted.

According to a fifth aspect of the present invention, in the device management system according to any one of the first to fourth aspects, when the management target device has been powered on or started up, the monitoring means may determine whether state information which is managed by the state management means has been changed from the state information stored in the information storage means.

A sixth aspect of the present invention is directed to a device management method of managing, by a management apparatus, information on a management target device, the method having: a transmission/reception process of transmitting, by the management apparatus, a transmission request to the management target device and receiving response information in response to the transmission request; and a management process of making, by the management apparatus, a request to the management target device to transmit change occurrence information on state information, determining whether the change occurrence information obtained from the management target device matches change occurrence information stored in advance in storage means, and outputting, if it is determined that they match, an instruction to display state information which is stored in advance in the storage means on display means, and making, if it is determined that they do not match, a request to the management target device to transmit the state information, outputting an instruction to display the state information which is obtained from the management target device on the display means, and storing the state information and the change occurrence information which are obtained from the management target device in the storage means.

According to a seventh aspect of the present invention, in the device management method, the change occurrence information stored in the information storage means of the management target device may be a counter value for a number of occurrences of changes and may be updated by incrementing the counter value.

According to an eighth aspect of the present invention, in the device management method, when the management target device has been powered on or started up, monitoring means of the management target device may determine whether state information which is managed by state management means of the management target device has been changed from the state information stored in the information storage means.

According to a ninth aspect of the present invention, in the device management method, the state information may be state information on whether an optional paper-feeding device and/or an optional paper-discharge device are/is mounted.

According to a tenth aspect of the present invention, in the device management method, the management target device may be an image forming apparatus.

An eleventh aspect of the present invention is directed to a storage medium in which a device management program that causes a management apparatus to perform a predetermined process for managing a management target device is stored, the device management program causing the management apparatus to perform: a transmission/reception process of transmitting a transmission request to the management target device and receiving response information in response to the transmission request; and a management process of making a request to the management target device to transmit change occurrence information on state information, determining whether the change occurrence information obtained from the management target device matches change occurrence information stored in advance in storage means, and outputting, if it is determined that they match, an instruction to display state information which is stored in advance in the storage means on display means, and making, if it is determined that they do not match, a request to the management target device to transmit the state information, outputting an instruction to display the state information which is obtained from the management target device on the display means, and storing the state information and the change occurrence information which are obtained from the management target device in the storage means.

According to a twelfth aspect of the present invention, the change occurrence information stored in the information storage means of the management target device may be a counter value for a number of occurrences of changes, and the device management program may cause the management target device to perform a process of updating the change occurrence information by incrementing the counter value.

According to a thirteenth aspect of the present invention, the device management program may cause monitoring means of, the management target device to perform a process of determining, when the management target device has been powered on or started up, whether state information which is managed by state management means of the management target device has been changed from the state information stored in the information storage means.

According to a fourteenth aspect of the present invention, the state information may be state information on whether an optional paper-feeding device and/or an optional paper-discharge device are/is mounted.

According to a fifteenth aspect of the present invention, the management target device may be an image forming apparatus.

According to the present invention, when change occurrence information obtained from the management target device matches change occurrence information stored in the storage means of the management apparatus, the management apparatus outputs an instruction to display state information which is stored in the storage means on the display means. When it is determined that they do not match, the management apparatus outputs an instruction to display state information which is obtained from the management target device on the display means.

Thus, only when change occurrence information obtained from the management target device does not match change occurrence information stored in the storage means of the management apparatus, the management apparatus accesses the management target device and obtains state information from the management target device.

By this, the processing load of the management apparatus can be reduced and the number of accesses to the management target device from the management apparatus can be reduced; accordingly, an advantageous effect that the traffic on a communication line can be reduced is obtained.

### BRIEF DESCRIPTION OF THE DRAWINGS

FIG. 1 is a block diagram showing a configuration of a device management system which is an exemplary embodiment of the present invention;

FIG. 2 is a diagram showing exemplary display of display means;

FIG. 3 is a diagram showing another exemplary display of the display means;

FIG. 4 is a flowchart showing an exemplary operation of an image forming apparatus; and

FIG. 5 is a flowchart showing an exemplary operation of a client apparatus.

### DESCRIPTION OF THE PREFERRED EMBODIMENT

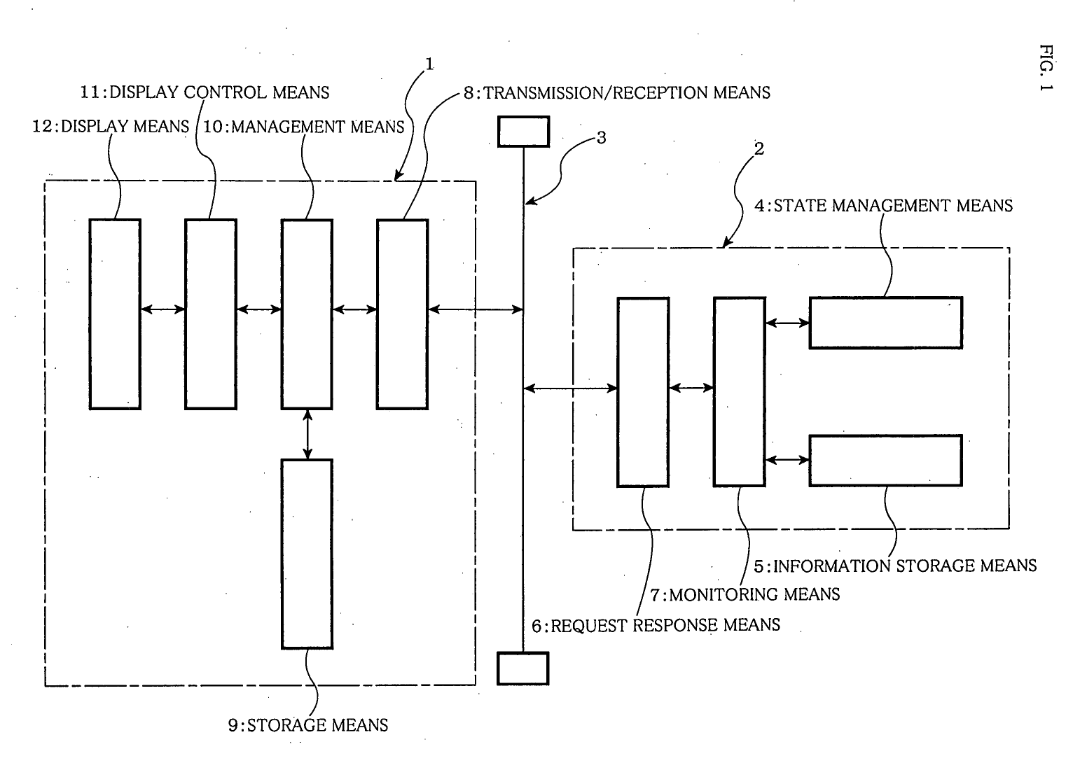

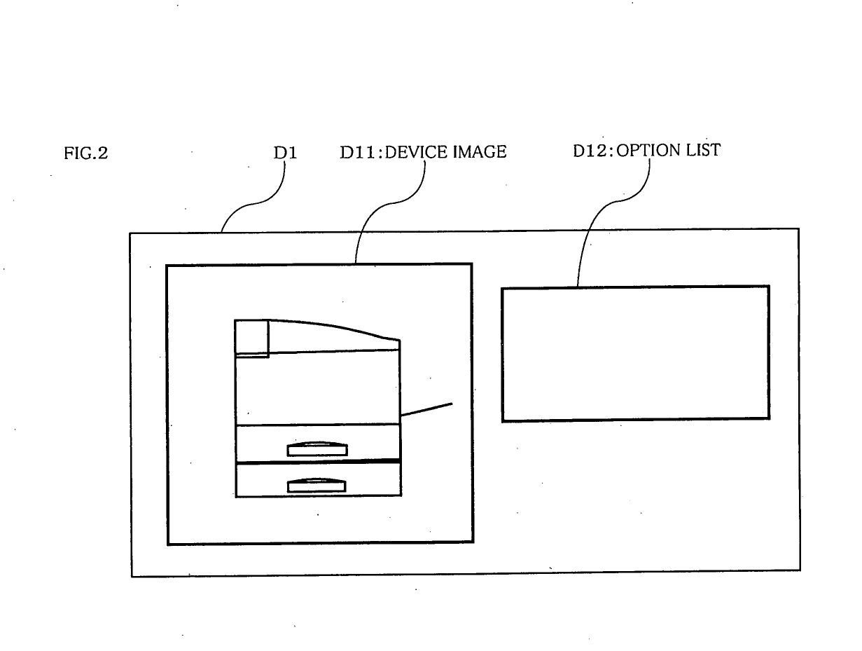

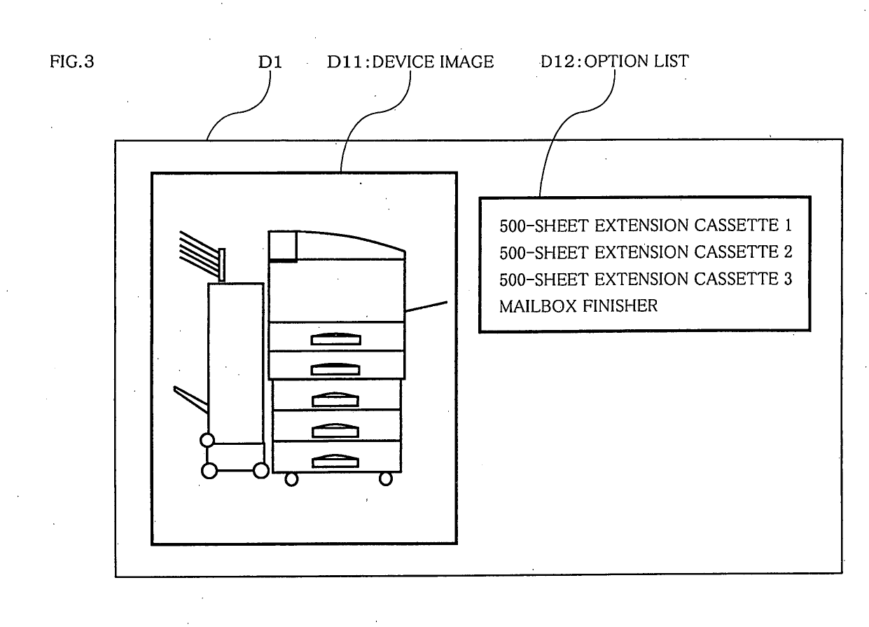

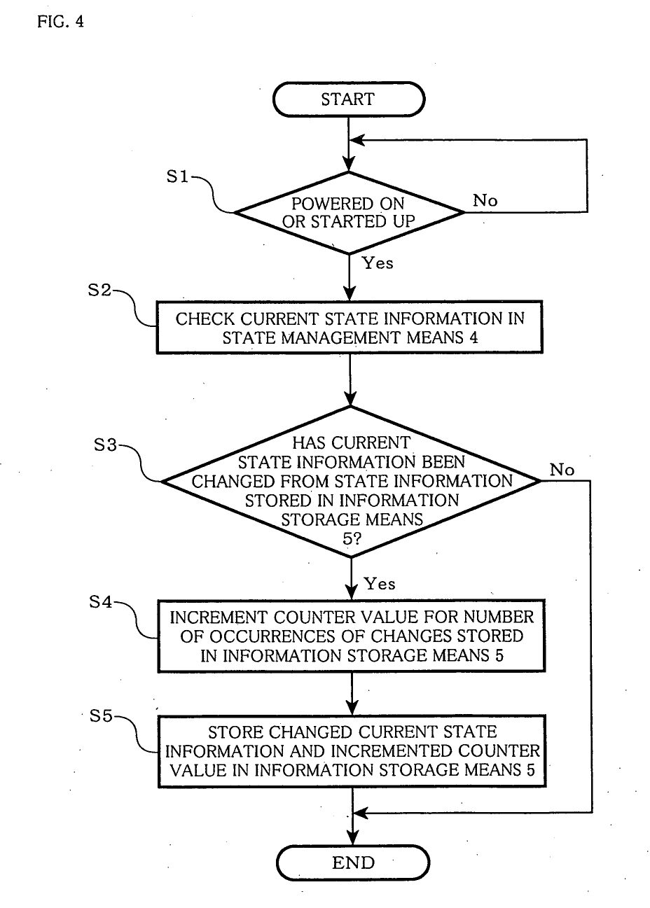

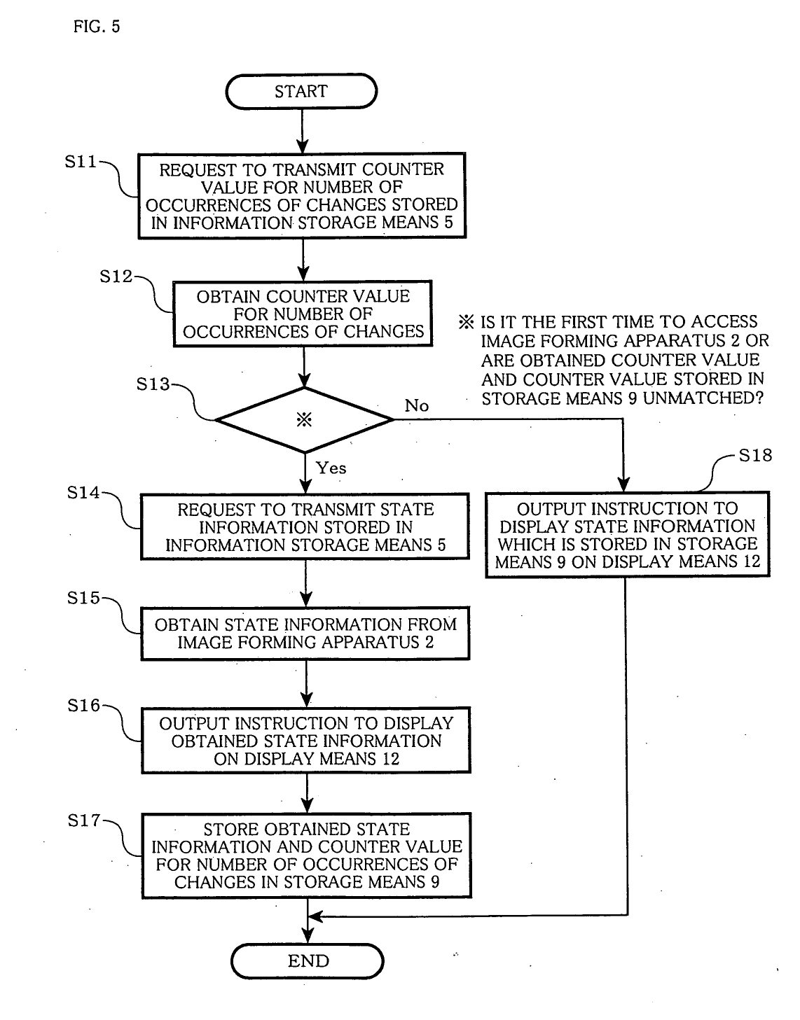

Now, an exemplary embodiment of the present invention will be described with reference to the drawings. FIG. 1 is a block diagram showing a configuration of a device management system which is an exemplary embodiment of the present invention. FIGS. 2 and 3 are diagrams showing exemplary display of display means. FIG. 4 is a flowchart showing an exemplary operation of an image forming apparatus. FIG. 5 is a flowchart showing an exemplary operation of a client apparatus.

As shown in FIG. 1, in the device management system which is the exemplary embodiment of the present invention, a client apparatus (management apparatus) 1 is connected, through a network interface (communication line) 3, to an image forming apparatus (management target device) 2 which is managed by the client apparatus 1.

First, for convenience of description, the image forming apparatus 2 will be described. The image forming apparatus 2 includes state management means 4, information storage means 5, request response means 6, and monitoring means 7. Processes of these means are performed such that a state monitoring program which is stored in storage means (e.g., a ROM or hard disk) is loaded into a RAM and then the program is executed by a CPU.

In the present embodiment, the state management means 4 manages a state of whether an extension paper-feeding cassette (optional paper-feeding device) and a mailbox finisher (optional paper-discharge device) of the image forming apparatus 2 are mounted.

The information storage means 5 functions as a MIB database and is composed of a storage apparatus such as a non-volatile memory (NVRAM). In the information storage means 5, state information on whether the extension paper-feeding cassette and the mailbox finisher are mounted is stored in advance and the number of occurrences of changes in the state information is stored as a counter value (change occurrence information).

The request response means 6 receives a transmission request from the client apparatus 1 and transmits response information in response to the transmission request.

The monitoring means 7 checks, when the image forming apparatus 2 has been powered on or started up, current state information in the state management means 4 and determines whether the current state information has been changed from state information stored in the information storage means 5. If it is determined that the state information has been changed, the monitoring means 7 increments the counter value for the number of occurrences of changes which is stored in the information storage means 5, and then stores the changed current state information and the incremented counter value in the information storage means 5.

In addition, when the request response means 6 receives a transmission request from the client apparatus 1, the monitoring means 7 outputs an instruction to the request response means 6 to transmit to the client apparatus 1 the state information or the counter value for the number of occurrences of changes, which is stored in the information storage means 5, in response to the transmission request.

Now, the client apparatus 1 will be described.

The client apparatus 1 obtains, by using an SNMP, the state information and the counter value for the number of occurrences of changes which are stored in the image forming apparatus 2, from installed application software (utility software, printer driver, etc.). As shown in FIG. 1, the client apparatus 1 includes transmission/reception means 8, storage means 9, management means 10, display control means 11, and display means 12. Processes of these means are performed such that a device management program which is stored in the storage means 9 (e.g., a ROM or hard disk) is loaded into a RAM and then the program is executed by a CPU.

The transmission/reception means 8 transmits to the image forming apparatus 2 a request to transmit the state information or the counter value for the number of occurrences of changes and receives response information in response to the transmission request. The storage means 9 stores the received state information and counter value for the number of occurrences of changes.

The management means 10 outputs to the transmission/reception means 8 an instruction to request the image forming apparatus 2 to transmit the counter value for the number of occurrences of changes which is stored in the information storage means 5, and determines whether the counter value for the number of occurrences of changes which is obtained from the image forming apparatus 2 matches the counter value for the number of occurrences of changes which is stored in the storage means 9.

If it is determined that they match, the management means 10 outputs to the display control means 11 an instruction to display state information which is stored in the storage means 9, i.e., state information on whether the extension paper-feeding cassette and the mailbox finisher are mounted, on the display means 12 such as a liquid crystal display panel.

On the other hand, if it is determined that they do not match or if it is the first time to access the image forming apparatus 2 (in this case, since there is no information stored in the storage means 9, they do not match), the management means 10 outputs to the transmission/reception means 8 an instruction to request the image forming apparatus 2 to transmit the state information stored in the information storage means 5, outputs to the display control means 11 an instruction to display on the display means 12 the state information which is obtained from the image forming apparatus 2, and stores in the storage means 9 the state information and counter value for the number of occurrences of changes which are obtained from the image forming apparatus 2.

Based on the state information outputted from the management means 10, the display means 12 displays, as shown in FIGS. 2 and 3, for example, a device image of the image forming apparatus 2 according to the state of mounting of extension paper-feeding cassettes and a mailbox finisher, and an option list of the extension paper-feeding cassettes and the mailbox finisher, for example. An exemplary device image of FIG. 2 shows a state in which optional devices, such as an extension paper-feeding cassette and a mailbox finisher, are not mounted on the image forming apparatus 2; thus, nothing is displayed in the option list. An exemplary device image of FIG. 3 shows a state in which three extension paper-feeding cassettes and a mailbox finisher are mounted on the image forming apparatus 2. Thus, a list of optional devices is displayed in the option list.

Now, an exemplary operation of the image forming apparatus 2 will be described with reference to FIG. 4. Note that steps S1 to S5 are performed by the monitoring means 7.

First, when, at step S1, the image forming apparatus 2 has been powered on or started up, at step S2, current state information in the state management means 4 is checked and a determination is made, at step S3, as to whether the current state information has been changed from state information which is stored in the information storage means 5.

If it is determined that the current state information has been changed, the process proceeds to step S4 where a counter value for the number of occurrences of changes which is stored in the information storage means 5 is incremented. At step S5, the changed current state information and the incremented counter value are stored in the information storage means 5.

Now, an exemplary operation of the client apparatus 1 will be described with reference to FIG. 5. Note that steps S11 to S18 are performed by the management means 10.

At step S11, a request is made to the image forming apparatus 2 to transmit a counter value for the number of occurrences of changes which is stored in the information storage means 5. Then, at step S12, the counter value for the number of occurrences of changes is obtained.

At step S13, if it is determined that it is the first time to access the image forming apparatus 2 or that the obtained counter value for the number of occurrences of changes and a counter value for the number of occurrences of changes which is stored in the storage means 9 are unmatched, the process proceeds to step S14. If they match, the process proceeds to step S18.

At step S14, a request is made to the image forming apparatus 2 to transmit state information stored in the information storage means 5. Then, at step S15, the state information is obtained from the image forming apparatus 2 and the process proceeds to step S16.

At step S16, an instruction to display the obtained state information on the display means 12 is outputted to the display control means 11. Then, at step S17, the obtained state information and counter value for the number of occurrences of changes are stored in the storage means 9.

At step S18, an instruction to display state information which is stored in the storage means 9 on the display means 12 is outputted to the display control means 11.

As is clear from the above description, in the present embodiment, when a counter value for the number of occurrences of changes which is obtained from the image forming apparatus 2 matches a counter value for the number of occurrences of changes which is stored in the storage means 9 of the client apparatus 1, the client apparatus 1 outputs an instruction to display state information which is stored in the storage means 9 on the display means 12. When it is determined that they do not match, the client apparatus 1 outputs an instruction to display state information which is obtained from the image forming apparatus 2 on the display means 12.

Therefore, only when a counter value for the number of occurrences of changes which is obtained from the image forming apparatus 2 does not match a counter value for the number of occurrences of changes which is stored in the storage means 9 of the client apparatus 1 (including the case in which it is the first time to access the image forming apparatus 2), the client apparatus 1 accesses the image forming apparatus 2 and obtains state information from the image forming apparatus 2.

By this, the processing load of the client apparatus 1 can be reduced and the number of accesses to the image forming apparatus 2 from the client apparatus 1 can be reduced. Accordingly, the traffic on the network interface 3 can be reduced.

In addition, by storing change occurrence information in the information storage means 5 of the image forming apparatus 2 as a counter value for the number of occurrences of changes and incrementing the counter value, the change occurrence information is updated. Thus, even when the image forming apparatus 2 is powered off, the change occurrence information stored in the information storage means 5 can be held.

Now, the device management program will be described.

A device management function of a computer (e.g., a management apparatus) in the aforementioned embodiment is implemented by a device management program which is stored in storage means (e.g., a ROM or HDD).

The device management program is read into control means (e.g., a CPU) of the computer, whereby instructions are sent to components of the computer and a device management process including, for example, a transmission/reception process, a management process, and a display process is performed.

The device management process is implemented by cooperation between the device management program which is software and the components of the computer (e.g., a management apparatus) which is a hardware resource.

The device management program used to implement the device management process of the present invention can be stored not only in the ROM or hard disk of the computer but also in a computer-readable storage medium such as an external storage apparatus or a portable storage medium.

Examples of the external storage apparatus include a memory expansion apparatus which incorporates a storage medium such as a CD-ROM and which is externally connected to a management apparatus or the like. Examples of the portable storage medium include a storage medium, such as a flexible disk, a memory card, or a magneto-optical disk, which is mountable on a storage medium drive apparatus (drive apparatus) and portable.

The program stored in a storage medium is loaded into the RAM or the like of the computer and executed by the CPU. By the execution, the aforementioned device management processing function is implemented.

Furthermore, when the device management program of the present invention is loaded on a computer, the device management program held on another computer can be downloaded to a RAM or external storage apparatus of a computer by using a communication line. The downloaded device management program is executed by a CPU, whereby the device management processing function according to the present embodiment is realized.

Note that the management apparatus, management target device, communication line, state management means, information storage means, request response means, monitoring means, transmission/reception means, storage means, display means, management means, state information, change occurrence information, etc., of the present invention are not limited to those exemplified in the aforementioned embodiment and can be appropriately modified without departing from the spirit and scope of the present invention.

For example, although the aforementioned embodiment exemplifies a client apparatus as a management apparatus, the present invention is not limited thereto and a management apparatus may be used as a management server and the aforementioned device management process may be performed in response to a request from a user terminal or the like. In this case, display control of state information is performed by display control means of the user terminal and the state information is displayed on a display unit (e.g., a display) of the user terminal.

Although the aforementioned embodiment exemplifies, as a management target device, an image forming apparatus such as a printer, a copying machine, a facsimile, a scanner, or a multifunction apparatus (MFP (multifunction peripheral)), the present invention is not limited thereto and a computer peripheral device, for example, may be used as a management target device.

The present invention relates to a management method for state information which indicates various states of a management target device, a device management system that performs the management method, a management program, and the like. Thus, the invention is applicable to a technical field that uses such management method, device management system, management program, and the like.

1. A device management system comprising:
state management means for managing state information on a management target device;
information storage means for storing the state information and change occurrence information on the state information;
request response means for transmitting response information in response to a transmission request from a management apparatus;
monitoring means for determining whether state information which is managed by the state management means has been changed from the state information stored in the information storage means, storing, if it is determined that the state information has been changed, the changed state information and updated information on the change occurrence information in the information storage means, and outputting, when receiving a transmission request from the management apparatus, to the request response means an instruction to transmit the state information or the change occurrence information which is stored in the information storage means to the management apparatus in response to the transmission request;
the management target device including the state management means, the information storage means, the request response means, and the monitoring means;
transmission/reception means for transmitting a transmission request to the management target device and receiving response information in response to the transmission request;
storage means for storing the state information and the change occurrence information;
management means for outputting to the transmission/reception means an instruction to request the management target device to transmit the change occurrence information, determining whether the change occurrence information obtained from the management target device matches the change occurrence information stored in the storage means, and outputting, if it is determined that they match, an instruction to display the state information which is stored in the storage means on display means, and outputting, if it is determined that they do not match, to the transmission/reception means an instruction to request to the management target device to transmit the state information, outputting an instruction to display the state information which is obtained from the management target device on the display means, and storing the state information and the change occurrence information which are obtained from the management target device in the storage means; and
the management apparatus including the transmission/reception means, the storage means, and the management means, and connected to the management target device through a communication line.

2. The device management system according to claim 1, wherein the change occurrence information stored in the information storage means is a counter value for a number of occurrences of changes and is updated by incrementing the counter value.

3. The device management system according to claim 1, wherein the management target device is an image forming apparatus.

4. The device management system according to claim 3, wherein the state information is state information on whether an optional paper-feeding device and/or an optional paper-discharge device are/is mounted.

5. The device management system according to claim 1, wherein when the management target device has been powered on or started up, the monitoring means determines whether state information which is managed by the state management means has been changed from the state information stored in the information storage means.

6. A device management method of managing, by a management apparatus, information on a management target device, the method comprising:
a transmission/reception process of transmitting, by the management apparatus, a transmission request to the management target device and receiving response information in response to the transmission request; and
a management process of making, by the management apparatus, a request to the management target device to transmit change occurrence information on state information, determining whether the change occurrence information obtained from the management target device matches change occurrence information stored in advance in storage means, and outputting, if it is determined that they match, an instruction to display state information which is stored in advance in the storage means on display means, and making, if it is determined that they do not match, a request to the management target device to transmit the state information, outputting an instruction to display the state information which is obtained from the management target device on the display means, and storing the state information and the change occurrence information which are obtained from the management target device in the storage means.

7. The device management method according to claim 6, wherein the change occurrence information stored in the information storage means of the management target device is a counter value for a number of occurrences of changes and is updated by incrementing the counter value.

8. The device management method according to claim 6, wherein when the management target device has been powered on or started up, monitoring means of the management target device determines whether state information which is managed by state management means of the management target device has been changed from the state information stored in the information storage means.

9. The device management method according to claim 6, wherein the state information is state information on whether an optional paper-feeding device and/or an optional paper-discharge device are/is mounted.

10. The device management method according to claim 6, wherein the management target device is an image forming apparatus.

11. A storage medium in which a device management program that causes a management apparatus to perform a predetermined process for managing a management target device is stored, the device management program causing the management apparatus to perform:
a transmission/reception process of transmitting a transmission request to the management target device and receiving response information in response to the transmission request; and
a management process of making a request to the management target device to transmit change occurrence information on state information, determining whether the change occurrence information obtained from the management target device matches change occurrence information stored in advance in storage means, and outputting, if it is determined that they match, an instruction to display state information which is stored in advance in the storage means on display means, and making, if it is determined that they do not match, a request to the management target device to transmit the state information, outputting an instruction to display the state information which is obtained from the management target device on the display means, and storing the state information and the change occurrence information which are obtained from the management target device in the storage means.

12. The storage medium according to claim 11, wherein
the change occurrence information stored in the information storage means of the management target device is a counter value for a number of occurrences of changes, and
the device management program causes the management target device to perform a process of updating the change occurrence information by incrementing the counter value.

13. The storage medium according to claim 12, wherein the device management program causes monitoring means of the management target device to perform a process of determining, when the management target device has been powered on or started up, whether state information which is managed by state management means of the management target device has been changed from the state information stored in the information storage means.

14. The storage medium according to claim 11, wherein the state information is state information on whether an optional paper-feeding device and/or an optional paper-discharge device are/is mounted.

15. The storage medium according to claim 11, wherein the management target device is an image forming apparatus.
